(19) United States
(12) Patent Application Publication
(10) Pub. No.: US 2019/0020258 A1
(43) Pub. Date: Jan. 17, 2019

(54) ROTARY OBJECT DRIVING AND POWER GENERATING SYSTEM

(71) Applicants: JHAO-TANG HUANG, Taipei City (TW); HUNG YI HUANG, Taipei City (TW)

(72) Inventors: JHAO-TANG HUANG, Taipei City (TW); HUNG YI HUANG, Taipei City (TW)

(21) Appl. No.: 15/648,461

(22) Filed: Jul. 13, 2017

(51) Int. Cl. H02K 47/00

(52) U.S. Cl. CPC H02K 47/00

(57) ABSTRACT

A rotary object driving and power generating system has a motor for driving a transversal rod, and then the transversal rod drives supporting rods which further drive the eccentric rotation device. The eccentric rotation device further drives a lower shaft so as to drive the power generator to generate electric power. Therefore power not used in the eccentric rotation device may be saved to drive the power generator to generate electric power and the electric power can be fed back to drive the eccentric rotation device so as to achieve the object of power saving.

### FIELD OF THE INVENTION

The present invention relates to power systems, and in particular to a rotary object driving and power generating system.

### BACKGROUND OF THE INVENTION

Conventional electric generation generally converts hydroelectric, thermo, piezoelectric, or gravitational energy. However, those processes all need to convert energy through mechanical work to drive the electric generator.

In the transformation of the mechanical energy to electricity, a great deal of energy will be lost due to mechanical loss among the process.

For example, there are many different kinds of rotary devices, such as carousels, etc. These devices are driven by motors. However, generally, these devices are power-ineffective and thus many powers are wasted. If people can reuse the power in the operation of these rotary devices, the power efficiency will be promoted. Furthermore, the power saved can also be fed back to the system.

Therefore, to increase the efficiency of electric generation by transmitting mechanical loss happened among the mechanism back to energy source is the main target of the inventor trying to achieve.

### SUMMARY OF THE INVENTION

Accordingly, the object of the present invention is to provide a rotary object driving and power generating system, wherein a motor serves to drive a transversal rod, and then the transversal rod drives supporting rods which further drive the eccentric rotation device. The eccentric rotation device further drives the lower shaft so as to drive the power generator to generate electric power. Therefore power not used in the eccentric rotation device may be saved to drive the power generator to generate electric power and the electric power can be fed back to drive the eccentric rotation device so as to achieve the object of power saving.

To achieve above object, the present invention provides a rotary object driving and power generating system, comprising: a power device connected to an external power source; the power device including: a motor having a spindle and installed upon an upper supporting plate; a power wire is connected to the motor; the power wire being connected to an external power source; a power transfer assembly connected to the power device for transferring power from the power device to following stages, the power transfer assembly including: a transversal rod having a middle section which is retained to the upper shaft; an upper end of the upper shaft being connected to an output shaft of the motor; when the motor actuates, the spindle of the motor and the upper shaft will drive the transversal rod; each distal end of the transversal rod being connected to a supporting rod; and thus when the transversal rod rotates, the supporting rods also rotate; an end of each supporting rod being connected to a rotation shaft; and two or more steel ropes being retained to a lower end of the rotation shaft; an eccentric rotation device connected to steel ropes of the power transfer assembly; an outer side of the eccentric rotation device being arranged with weights for generating large torques; the power transfer assembly will drive the eccentric rotation device and thus the weights and the eccentric rotation device rotates around the rotation shaft; a power generating set engaging to a lower shaft of the eccentric rotation device by a gear set for transferring the power from the lower shaft to a power generator so as to drive a spindle of the power generator; and thus, the power generator generating electric power.

### BRIEF DESCRIPTION OF DRAWINGS

FIG. 1 is a block diagram of the present invention.

FIG. 2 is a schematic view showing the elements of the present invention.

FIG. 3 is a perspective view of the present invention.

FIG. 4 is a partial schematic view of the present invention.

FIG. 5 is another schematic view of the present invention.

### BRIEF DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

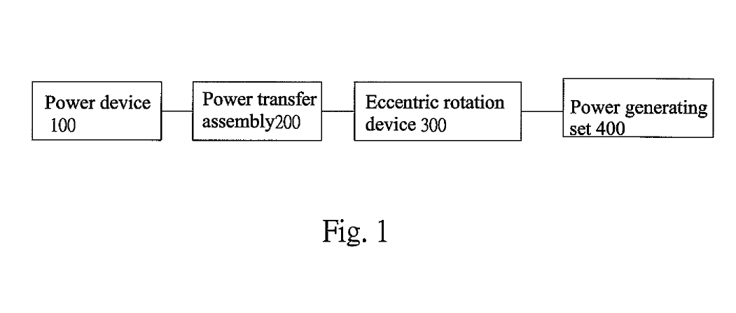

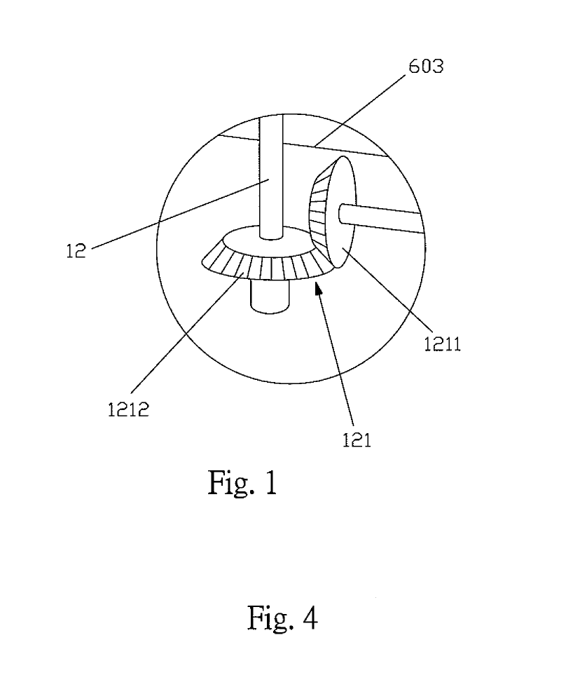

With reference to FIGS. 1 to 5, the rotary object driving and power generating system of the present invention is illustrated. The present invention includes the following elements

A power transfer device 100, as illustrated in FIG. 1, serves to supply power to the system of the present invention. The power device 100 is connected to an external power source. The power device 100 includes the following elements.

A motor 3, see FIG. 1, has a spindle 30 and is installed upon an upper supporting plate 601.

A power wire 2 is connected to the motor 3. The power wire 2 is connected to an external power source (not shown).

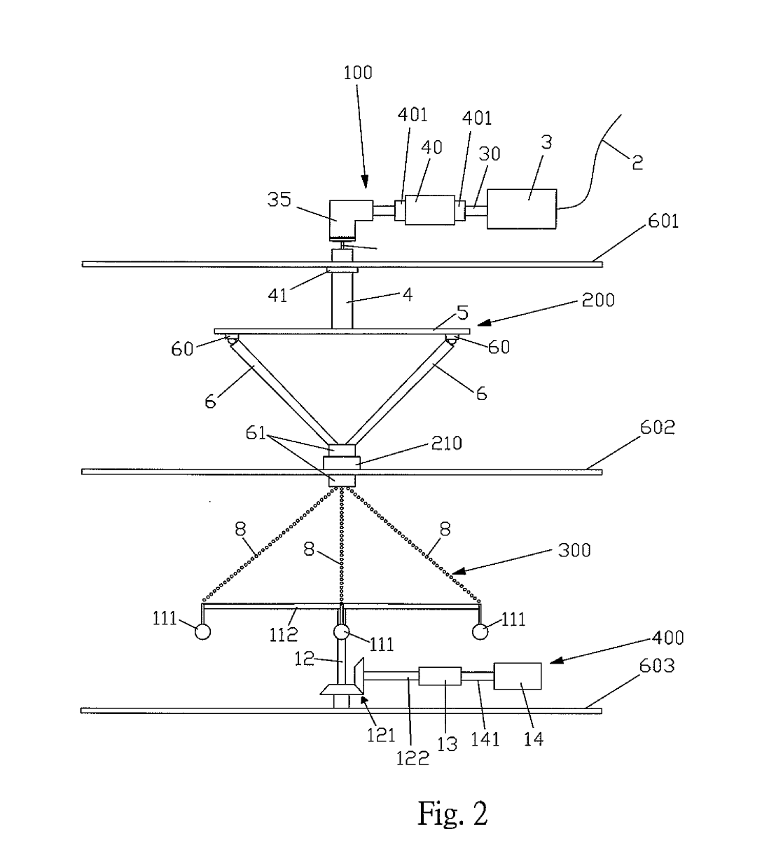

A speed reduction machine 40 may be further included in the present invention. The speed reduction machine 40 has an input end connected to the motor 3 (through, for example, a belt (not shown)) for controlling and reducing the speed. The speed reduction machine 40 has a speed reduction ratio of N:1. Two ends of the speed reduction machine 40 may be installed with bearings 401 for retaining the operation thereof (referring to FIG. 2).

A power transfer assembly 200 is connected to the power device 100 for transferring power from the power device 100 to the next stage.

A direction change device 35 may be installed between the power transfer assembly 200 and the speed reduction machine 40 so as to change the direction of the output of the speed reduction machine 40.

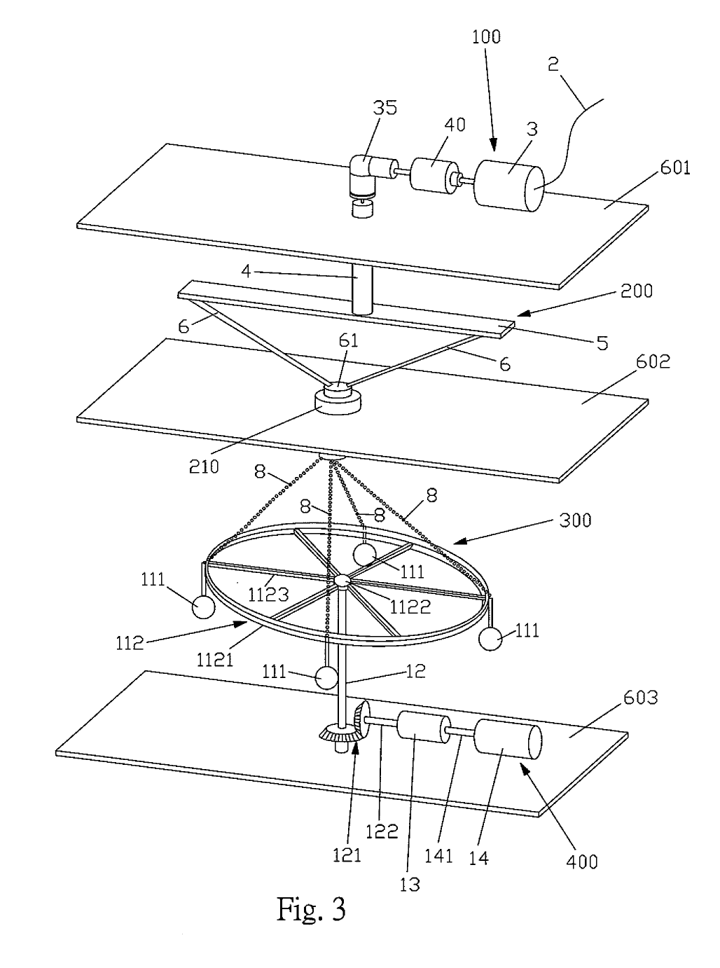

As illustrated in FIG. 3, the power transfer assembly 200 includes the following elements.

A transversal rod 5 has a middle section which is retained to the upper shaft 4. An upper end of the upper shaft 4 is connected to an output shaft of the speed reduction machine 40 (or an end of the direction change device 35) by a bearing 41 supported at a lower side of the upper supporting plate 601. When the motor 3 actuates, the spindle 30 of the motor 3 and the upper shaft 4 will drive the transversal rod 5.

Each distal end of the transversal rod 5 is connected to a supporting rod 6 through a bearing 60. Therefore when the transversal rod 5 rotates, the two supporting rods 6 also rotate through 360 degrees. Another end of each supporting rod 6 is connected to a rotation shaft 61.

The rotation shaft 61 passes through a middle supporting plate 602 by a bearing 210 around the rotation shaft 61 and on the middle supporting plate 602.

Four steel ropes 8 are retained to a lower end of the rotation shaft 61.

An eccentric rotation device 300 is connected to steel ropes 8 of the power transfer assembly 200. Outer side of the eccentric rotation device 300 is arranged with weights 111 for generating large torques. The power transfer assembly 200 will drive the eccentric rotation device 300 and thus the weights 111. The eccentric rotation device 300 may rotate around the rotation shaft 61.

In this example, the eccentric rotation device 300 is an eccentric frame 112. An outer side of the eccentric frame 112 is installed with four weights 111 suspending therefrom.

The eccentric frame 112 includes a round frame 1121, a central shaft 1122 and a plurality of connecting rods 1132 connected between the round shaft 1121 and the central shaft 1122.

The four steel ropes 8 are connected between the round frame 1121 and the rotation shaft 61. Therefore when the rotation shaft 61 rotates, the eccentric frame 112 will be driven through the steel ropes 8 and thus all the weights 111 rotate therewith. Therefore the whole eccentric rotation device 300 rotates. In this example, the weights 111 may be iron balls.

A lower shaft 12 has one end connected to the central shaft 1122 of the eccentric rotation device 300. Another end of the lower shaft 12 is rotatably engaged into a lower retaining seat 603.

A power generating set 400 is connected to the lower shaft 12 for transferring the power from the lower shaft 12 to a power generator 14 so as to drive a spindle 141 of the power generator 14. Thus, the power generator 14 generates electric power. The power generating set 400 includes following elements.

A gear set 121 serves for transferring rotation from the lower shaft 12 to a driven shaft 122. The gear set 121 may include an umbrella gear 1212 installed on the lower shaft 12 and another umbrella gear 1211 installed on the driven set.

A power generator 14 has the spindle 141 coupling to another end of the driven shaft 122. Therefore the lower shaft 12 drives the driven shaft 122 and thus drive the power generator 14 to generate electric power.

A second speed reduction machine 13 may be installed between the driven shaft 122 and the power generator 14.

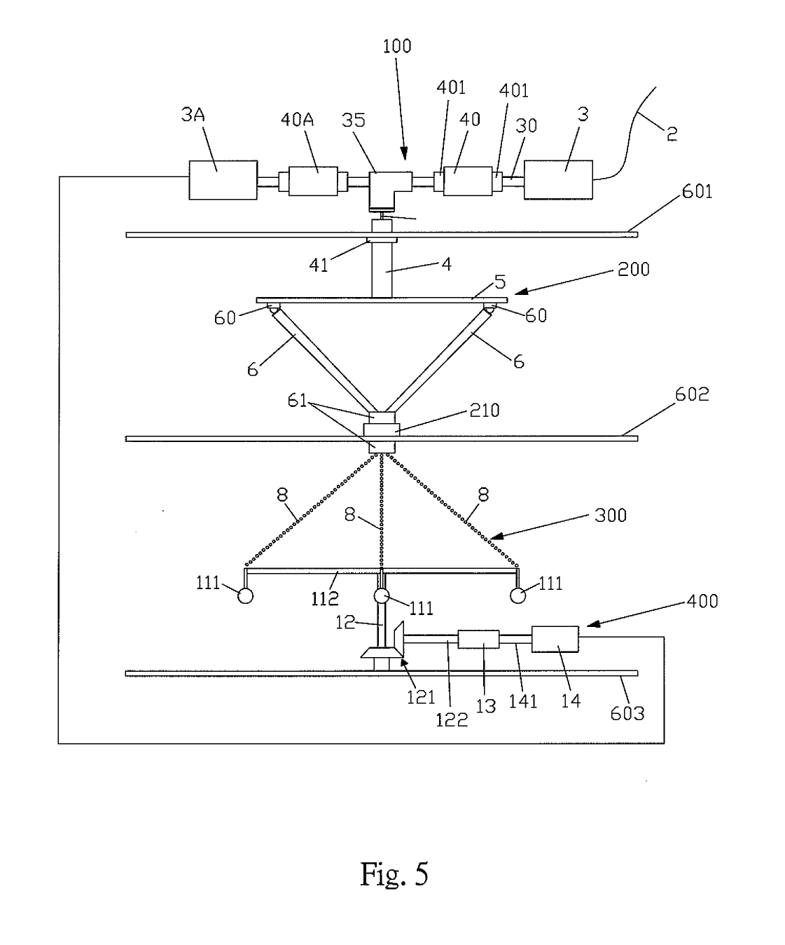

As illustrated in FIG. 5, in the present invention, another end of the direction change device 35 may be connected to a third speed reduction machine 40A. The third speed reduction machine 40A is further connected to a third motor 3A and the third motor 3A is electrically connected to the power generator 14 for receiving electrical power from the power generator 14. Therefore power from the power generator 14 can drive the third motor 3A and thus through the direction change device 35, the third motor 3A can drive the power transfer assembly 200. Thus, power from the power generator 14 is fed back to the power transfer assembly 200 so as to achieve the object power saving.

In the present invention, a motor serves to drive a transversal rod, and then the transversal rod drives supporting rods which further drive the eccentric rotation device. The eccentric rotation device further drives the lower shaft so as to drive the power generator to generate electric power. Therefore power not used in the eccentric rotation device may be saved to drive the power generator to generate electric power and the electric power can be fed back to drive the eccentric rotation device so as to achieve the object of power saving.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A rotary object driving and power generating system, comprising:
a power device connected to an external power source; the power device including:
a motor having a spindle and installed upon an upper supporting plate; a power transfer assembly connected to the power device for transferring power from the power device to following stages, the power transfer assembly including:
a transversal rod having a middle section which is retained to the upper shaft; an upper end of the upper shaft being connected to an output shaft of the motor; when the motor actuates, the spindle of the motor and the upper shaft will drive the transversal rod; and each distal end of the transversal rod being connected to a supporting rod; and thus when the transversal rod rotates, the supporting rods also rotate; an end of each supporting rod being connected to a rotation shaft; and
two or more steel ropes being retained to a lower end of the rotation shaft; and
an eccentric rotation device connected to steel ropes of the power transfer assembly; an outer side of the eccentric rotation device being arranged with weights for generating large torques; the power transfer assembly will drive the eccentric rotation device and thus the weights and the eccentric rotation device rotates around the rotation shaft; and
a power generating set engaging to a lower shaft of the eccentric rotation device by a gear set for transferring the power from the lower shaft to a power generator so as to drive a spindle of the power generator; and thus, the power generator generating electric power.

2. The rotary object driving and power generating system as claimed in claim 1, wherein a first speed reduction machine has an input end connected to the motor for controlling and reducing the speed.

3. The rotary object driving and power generating system as claimed in claim 2, wherein a direction change device is installed between the power transfer assembly and the first speed reduction machine so as to change the direction of the output of the first speed reduction machine.

4. The rotary object driving and power generating system as claimed in claim 3, wherein another end of the direction change device is connected to a third speed reduction machine; and the third speed reduction machine is further connected to a third motor and the third motor is electrically connected to the power generator for receiving electrical power from the power generator.

5. The rotary object driving and power generating system as claimed in claim 1, wherein the rotation shaft passes through a middle supporting plate by a bearing around the rotation shaft and on the middle supporting plate.

6. The rotary object driving and power generating system as claimed in claim 1, wherein the eccentric rotation device is an eccentric frame; and an outer side of the eccentric frame is installed with four weights suspending therefrom;
the eccentric frame including a round frame, a central shaft and a plurality of connecting rods connected between the round shaft and the central shaft; and
the four steel ropes are connected between the round frame and the rotation shaft.

7. The rotary object driving and power generating system as claimed in claim 6, wherein a lower shaft has one end connected to the central shaft of the eccentric rotation device; and another end of the lower shaft is rotatably engaged into a lower retaining seat; and
the power generating set including:
a gear set for transferring rotation from the lower shaft to a driven shaft; the gear set including a first umbrella gear installed on the lower shaft and a second umbrella gear installed on the driven set and engaged to the first umbrella gear; the power generator having the spindle coupling to another end of the driven shaft; therefore the lower shaft driving the driven shaft and thus drive the power generator to generate electric power.

8. The rotary object driving and power generating system as claimed in claim 1, wherein a second speed reduction machine is installed between the driven shaft and the power generator.
